(19) United States
(12) Patent Application Publication
(10) Pub. No.: US 2015/0147739 A1
(43) Pub. Date: May 28, 2015

(54) LEARNING SYSTEM USING OID PEN AND LEARNING METHOD THEREOF

(71) Applicant: Bunny Land Co., Ltd., Namyangju-si (KR)

(72) Inventors: Je-Woo PARK, Namyangju-si (KR); Eui-Sung PARK, Seongnam-si (KR)

(21) Appl. No.: 14/554,996

(22) Filed: Nov. 26, 2014

(30) Foreign Application Priority Data
Nov. 27, 2013 (KR) 10-2013-0145099

(51) Int. Cl. G09B 5/06

(52) U.S. Cl. CPC G09B 5/062; G06K 2007/10524
USPC 434/308

(57) ABSTRACT

The present invention relates to a learning system using an OID pen, the learning system including a plurality of textbooks, in which texts and drawings are formed in a dot code, an OID pen to read and decode dot code information formed in a corresponding area when a specific area of the textbook is touched by the OID pen and generate a digital code based on the dot code information, and a smartphone to store content information and operating application corresponding to each textbook at a designated area, wherein the OID pen is connected to the smartphone, any one content corresponding to each textbook may be selected, and corresponding image data or audio data of the content based on the digital code determined when the dot code is read by the OID pen are loaded and outputted.

### FIELD OF THE INVENTION

The present invention relates to a learning system using an OID (Optical Identification Device) pen, more particularly, to a learning system using an OID pen, which does not require a set-top box having contents thus is inexpensive and easily usable.

In addition, the present invention allows each teacher to proactively teach according to his or her style and method.

### DESCRIPTION OF THE RELATED ART

In general, a learning system using an OID pen is a learning apparatus, which is mainly used by children in early grades to learn a foreign language.

The learning system includes: a textbook in which printed materials including a text and a drawing are prepared in the form of a dot code, which is a set of 16 dots provided in an area of 2 mm×2 mm; an OID pen to read the dot code of the textbook through an OID lens to generate a digital code recognizable by a set-top box; and a set-top box to load corresponding audio data based on the digital code generated by the OID pen and output the audio data.

When the OID pen touches a specific area of the textbook, the OID pen reads and decodes the dot code of the corresponding area, and the set-top box connected to the OID pen loads the corresponding audio data to output related information to the outside.

Thus, children can learn with interest while identifying the learning material by touching specific parts of the textbook using the OID pen according to instructions of a teacher.

For reference, the learning apparatus includes a display device or a server according to embodiments, and when the set-top box is connected to the display device, related images and audios are outputted through the display device thus further maximizing the effectiveness of learning. (Korea registered patent publication No. 10-113993).

However, the learning apparatus is inconvenient in that a memory card, in which content information is stored for each textbook, needs to be purchased and installed into the set-top box, and only limited content related to the textbook is serviceable.

Especially the set-top box is expensive and the memory card, in which the content is stored, is purchased for each textbook thus not only is the propagation of the learning apparatus difficult, but also much cost is consumed.

In addition, because the apparatus is for the student not for the teacher, when the teacher uses the apparatus for teaching the children, only the given content, which is identical to that of the student, is serviceable. That is, even though teachers have their own method and style for teaching students, the teachers using the apparatus can only teach students by the same method while passively reproducing the content.

As related arts, there are Korean Patent Application No. 10-2012-0109482 (Sep. 9, 2012), Korean Registered Patent Publication No. 10-1310896 (Registered on Sep. 13, 2013) and Korean Registered Patent Publication No. 10-1139993 (Registered on Apr. 18, 2013).

### SUMMARY OF THE INVENTION

An object of the present invention is to provide a learning apparatus, which can be propagated at a low cost without using a set-top box and can allow users to freely use related content corresponding to each textbook, and especially, when a teacher teaches a student using the apparatus, each teacher can proactively teach according to his or her teaching method or style.

To this end, a learning system of the present invention includes:

a plurality of textbooks in which printed materials including a text and a drawing are prepared in a form of a dot code, which is a set of a plurality of dots provided in an area of 2 mm×2 mm; an OID pen including an OID lens to recognize the dot code printed in the textbook through an exposing hole formed at a front end of the OID pen and a code conversion unit to decode dot code information obtained from the OID lens to generate a digital code; and a smartphone connected to the OID pen including a storage unit to store content information and an operating application corresponding to each textbook in a designated area, a controller to load audio data or image data from a corresponding content of a registered contents when the operating application is operated, and an output unit to output the audio data or the image data, which are loaded by the controller, wherein, when the operating application, which is stored in the smartphone, is operated, any one of the content corresponding to each textbook is selectable, and when the OID pen reads the dot code, the smartphone loads the image data or the audio data of the corresponding content based on the determined digital code and outputs the data to a display panel.

The present invention provides a learning system by connecting an OID pen and a smartphone, which stores an operating application and contents, so that a separate set-top box and a memory card are not required thus the system can be propagated at a low cost and related contents corresponding to each textbook can be freely used.

In addition, the present invention allows each teacher to alter the related content according to his or her style and method when teaching students using the OID pen, so that the teacher can proactively teach the student.

### BRIEF DESCRIPTION OF THE DRAWINGS

FIG. 1 is an exemplary view showing a learning system according to an embodiment of the present invention.

FIG. 2 is a view showing the learning system according to an embodiment of the present invention in use.

FIG. 3 is a block diagram of the learning system according to an embodiment of the present invention.

FIG. 4 is a block diagram of a smartphone according to an embodiment of the present invention.

FIG. 5 is a registration screen of the smartphone according to an embodiment of the present invention.

FIG. 6 is a flowchart illustrating a registration process of user contents according to an embodiment of the present invention.

FIG. 7 is a flowchart illustrating the learning system according to an embodiment of the present invention.

FIG. 8 is a flowchart according to an embodiment of the present invention.

### DETAILED DESCRIPTION OF THE INVENTION

Hereinafter, an embodiment of the present invention is described in detail in reference to the accompanying drawings.

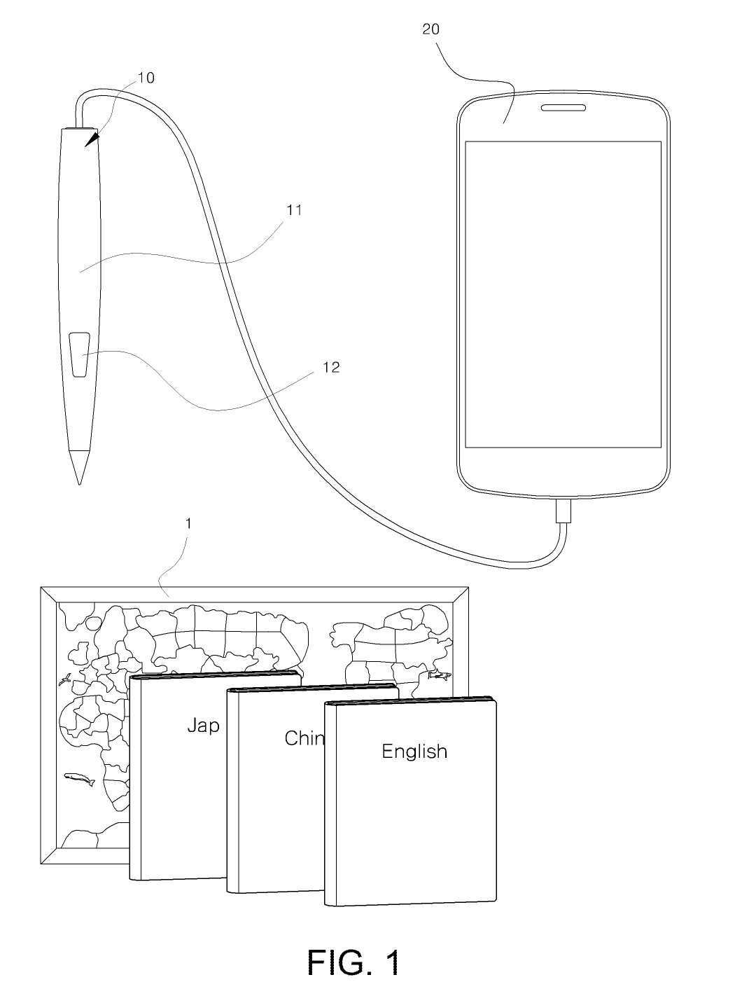

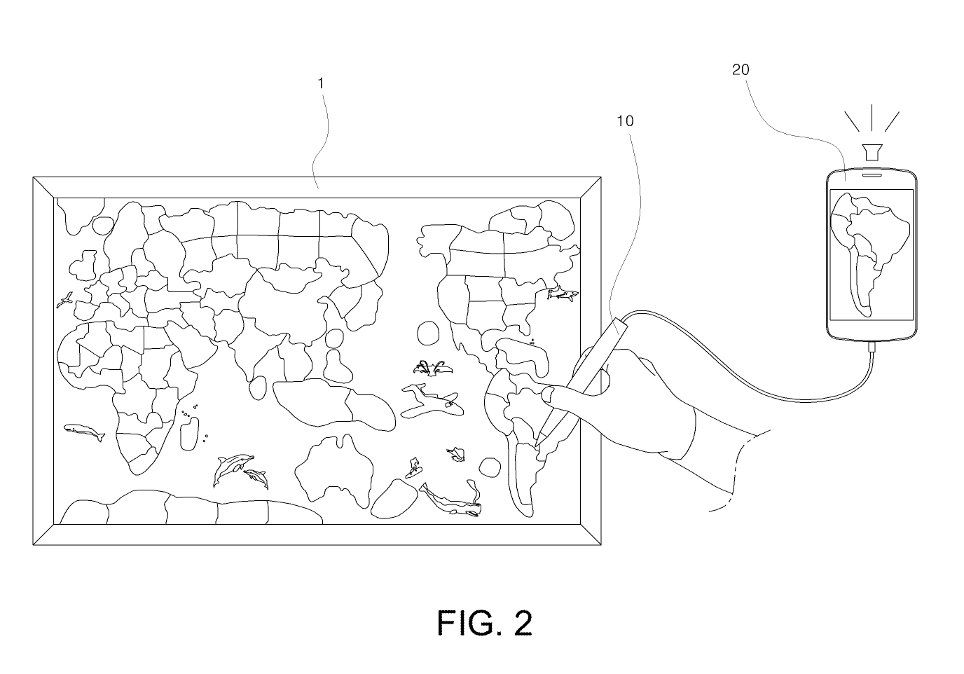

First, FIG. 1 is a simple illustration of an overall configuration of a system according to an embodiment of the present invention and FIG. 2 is a simple view showing the learning system according to an embodiment of the present invention in use.

As illustrated, the present invention includes: a plurality of textbooks 1, in which a text and a drawing are prepared in a form of a dot code; an OID 10 pen to read and decode dot code information formed in a corresponding area when a specific area of the textbook 1 is touched by the OID pen and generate a digital code based on the dot code information; and a smartphone 20 connected to the OID pen to store content information and an operating application corresponding to each textbook at a designated area, wherein any one of the contents corresponding to each textbook 1 may be selectable when the operating application of the smartphone 20 is operated, and a corresponding image data or audio data of the content based on the digital code, which is determined when the dot code is read by the OID pen 10, are loaded and outputted so that the OID pen 10 can be propagated at a low cost, and related contents corresponding to each textbook can be conveniently and freely used.

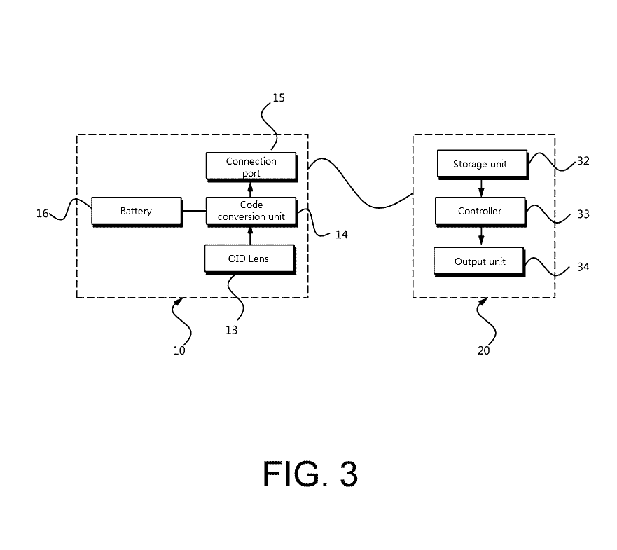

For reference, the OID pen 10, as illustrated in FIG. 3, includes an instruction button 12 straightly formed on a body 11 to be repetitively pushed by an elastic force, an exposing hole formed by cutting out a part of a front end of the OID pen and an OID lens 13 provided inside the exposing hole. And a PCB board, which is connected to the OID lens 13, is provided at an inner part of the body 11 of the OID pen, and a connection port 15 is formed on an upper part of the body of the OID pen to be connected to the smartphone so that the dot code is read when the OID lens 13, which is formed at a front end of the body 11, touches a specific area of the textbook 1, a code conversion unit 14 of the PCB board, which is connected to the OID lens, converts the dot code to a digital code, and the digital code is transmitted to the smartphone 20 through the connection port 15 formed on the upper part of the body 11, so that the smartphone 20 obtains the digital code.

For reference, according to embodiments, the OID pen 10 may include a Bluetooth module or a Wi-Fi module to form a channel with the smartphone instead of the connection port 15.

In addition, the code conversion unit 14 decodes image information or optical information of a reflected wave obtained through the OID lens 13 according to a designated rule to convert the information to the digital code recognizable by the smartphone.

Further, the OID pen 10 may include a battery 16 inside the body, and the OID pen may also be operated by a power supplied from a battery embedded in the smartphone by connecting the OID pen to the smartphone.

In addition, the smartphone 20 connected to the OID pen includes: a storage unit 32 to store the content information and the operating application corresponding to each textbook 1 in the designated area; a controller 33, which is an AP chip, to load the audio data or the image data from the contents corresponding to a digital code, which is registered when the operating application is operated, stored in the storage unit; and an output unit 34 to output the audio data or the image data, which is loaded by the controller, to a display panel or a speaker, wherein when the operating application of the smartphone 20 is operated, any one of the multiple contents is selected and registered, and the audio data and the image data corresponding to the registered content based on the digital code obtained from the OID pen 10 are loaded and outputted so that children can obtain related information by touching the textbook through the OID pen when requiring information.

For reference, the controller is the AP chip of the smartphone, and the output unit is the speaker and the display panel, which are controlled by a playing module.

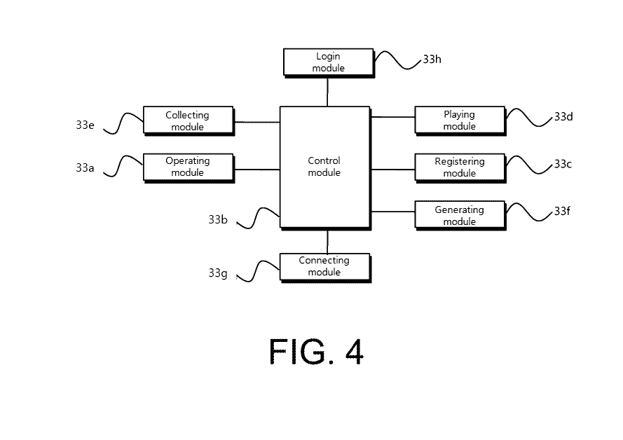

In addition, the smartphone 30, as illustrated in FIG. 4, includes an operating module 33a, a control module 33b, a registering module 33c, a playing module 33d, a collecting module 33e and a generating module 33f. For reference, each module in this case defines a functional and a structural combination of hardware and software to execute a technological idea of the present invention.

First, the operating module 33a controls the control module 33b when the operating application is operated to identify an item of each content stored in the storage unit 32 and instructs to display the item to an opened screen.

Further, when the item of the content stored by the instruction of the operating module 33a is opened on the screen as an icon, the registering module requests a touch input of a specific content item icon among a plurality of content item icons 21 which are opened on the screen.

In addition, when the input is completed, the registering module loads the corresponding content item and outputs the audio data and the image data related to the corresponding content.

In this case, on the screen opened by the operating module 33a, according to embodiments, a connection module 33g to connect to a specific WAP (Wireless Application Protocol) page to download a new content and a login module 33f to request an ID or a password may further be included.

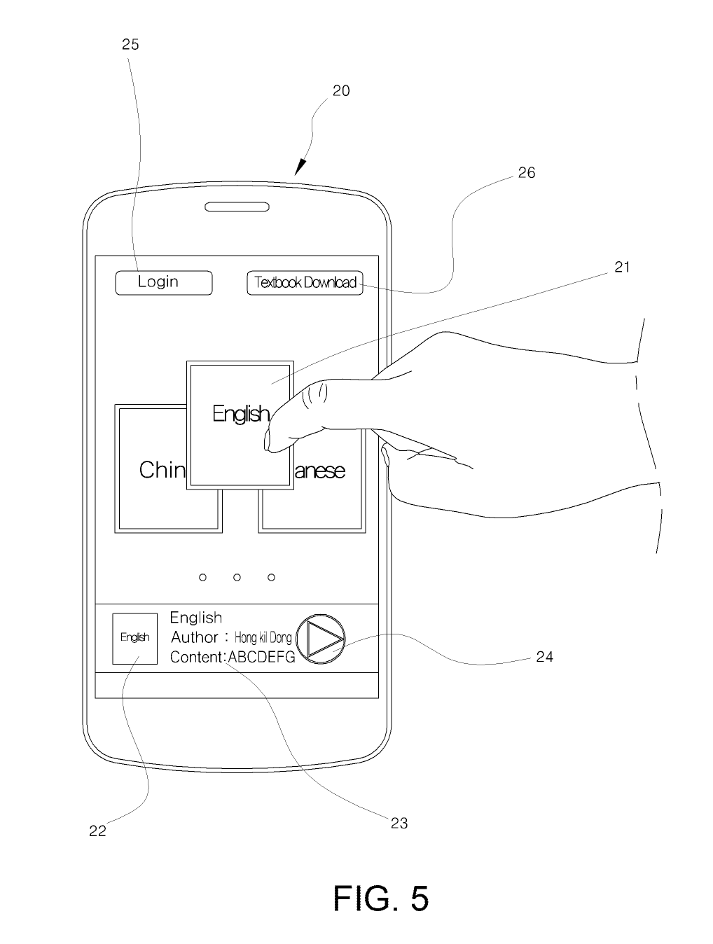

That is, as illustrated in FIG. 5, when the operating application installed in the smartphone is operated, the control module 33b controls the playing module 33d according to the instruction of the operating module 33a to open a main screen in the display panel.

In this case, the control module 33b verifies various content items stored in the storage unit 32 according to the instruction of the operating module 33a and converts the items into icons and displays the icons on the opened screen.

For reference, the content item icon 21 displayed at this time is expressed in a state that a front page of each textbook is listed, and according to embodiments, a first content item icon is arranged while protruding at a center of the screen and a second content icon is arranged at left and right sides of the first content item while forming layers so that the content item icons disposed at the sides are sequentially rotated and protrude at the center by sliding the icons left and right.

Further, when a specific content item icon among the arranged content item icon 21 is touched, the selected content item icon 22 is displayed at a lower end of the screen along with related information through a text part 23. In this case, when the playing button 24, which is formed on a side of the screen, is pressed, the corresponding content is registered, and the image data and the audio data of the related content may be loaded and played through the OID pen 10.

For reference, in the present invention, a learning download button 26 to download other content information by the connecting module 33g through connecting to a WEB server or a WOP server instead from the multiple contents stored on the storage unit and a login button 25 to obtain authorization by the operating application or connecting to a WOP server/WEB server may further be provided on an upper part of the screen.

In addition, when the OID pen 10 and the smartphone 20 are connected, the OID pen reads the dot code by touching a specific area of the textbook 1, the collecting module 33e collects the digital code generated by the OID pen 10 and reports the digital code to the control module 33b.

In this case, the control module 33b identifies the corresponding content registered through the registering module 33c, loads the corresponding audio data and image data from the registered corresponding content based on the digital code collected through the collecting module 33e, and instructs the playing module to output the data.

In this case, the control module 33b identifies the multiple contents stored in the storage unit 32 according to the instruction of the operating module 33a and iconifies the item of the corresponding content to display on the screen.

For reference, the playing module 33d controls the display panel of the speaker according to the instruction of the control module 33b to play an image or an audio by externally outputting the loaded audio data and the image data.

In addition, the generating module 33f requests an input of a new image, text information or audio information through opened user input content buttons and adds, deletes or alters the audio data or the image data loaded through the digital code obtained through the collecting module 33e when the input is completed.

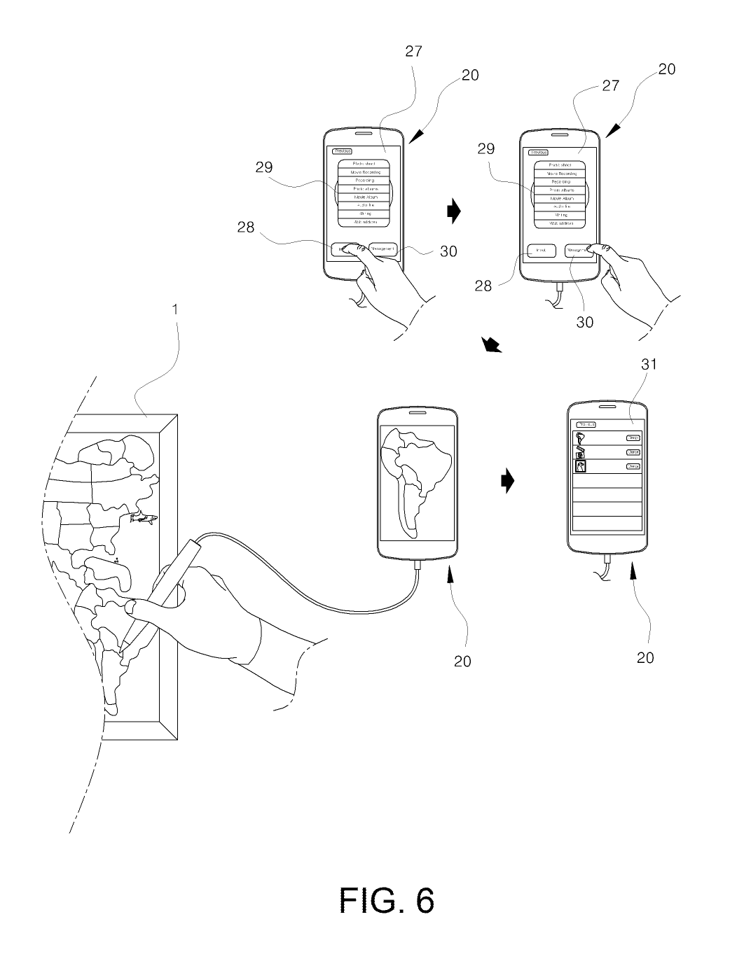

That is, as illustrated in FIG. 6, when the specific content is registered by pressing the playing button 24, a new screen is opened, and in this case, when the user content input button 28 provided on a lower end of the opened user content registration window 27 is pressed, multiple interface buttons 29 are opened so that the new image data, the new audio data and text data may be inputted.

In this case, when the new image data or the audio data are inputted by pressing the exposed multiple interface buttons, a user content management button 30, which is implemented at a lower end of the screen, is pressed to enter a management mode.

In this case, the multiple image data or audio data, which are arranged in the management window, may be directly altered by entering the management mode, but when the OID pen 10 touches a specific area of the textbook 1, the decoded digital code is obtained and the newly inputted image data or the audio data are added, deleted or altered when the audio data or the image data of the corresponding area are opened in a management window 31 based on the digital code so that the modified image data or the audio data are outputted.

Therefore, an embodiment of the present invention uses the OID pen 10 by connecting the OID pen 10 to the smartphone in such a manner that the system can be propagated at a lower cost because a separate set-top box or a memory card is not required, and related content corresponding to each textbook can be freely used.

In addition, the present invention allows each teacher to alter the related content according to his or her style and method when teaching students using the OID pen 10.

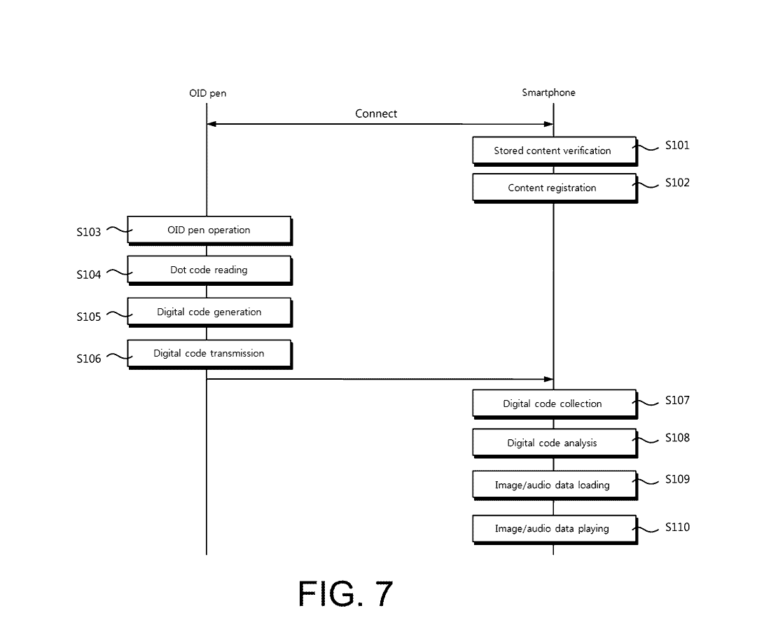

Hereinafter, an operating process of the system according to an embodiment of the present invention will be described with reference to FIG. 7. First, according to the present invention, the OID pen is connected to the smartphone and the operating application stored in the storage unit in the smartphone is executed.

In this case, the smartphone is implemented in such a manner that the operating application operates through the touch input.

According to embodiments, when the connection between the smartphone and the OID pen is identified, the operating application may automatically operate according to a profile.

In addition, when the smartphone operates the operating application of the smartphone in this manner, the main screen is opened and the operating module controls the control module to identify the content stored in the storage unit and opens the item icon of the content on the screen.

Further, the item icon of the specific content among the multiple content item icons, which are displayed on the screen of the smartphone, is touched and registered.

Then, when the OID pen touches the specific area of the specific textbook, the OID lens provided in the front end of the OID pen reads the dot code touched by the OID pen, the code conversion unit, which is provided at an inner part of the body, decodes the dot code read from the OID lens to convert the dot code into the digital code, and the OID pen transmits the digital code to the smartphone through the connection port formed on an upper part of the OID pen.

In this case, according to embodiments, the OID pen may transmit the decoded digital code to the smartphone by embedding the Wi-Fi module or the Bluetooth module to form the channel with the smartphone instead of the connection port.

In addition, in the smartphone connected to the OID pen, the collecting module collects the transmitted digital code to report to the control module, and the control module loads the audio data and the image data corresponding to the digital code.

In this case, the playing module outputs the audio data and the image data loaded according to the instruction of the control module so that students can easily learn at a low cost even when a separate set-top box and a memory card is not provided.

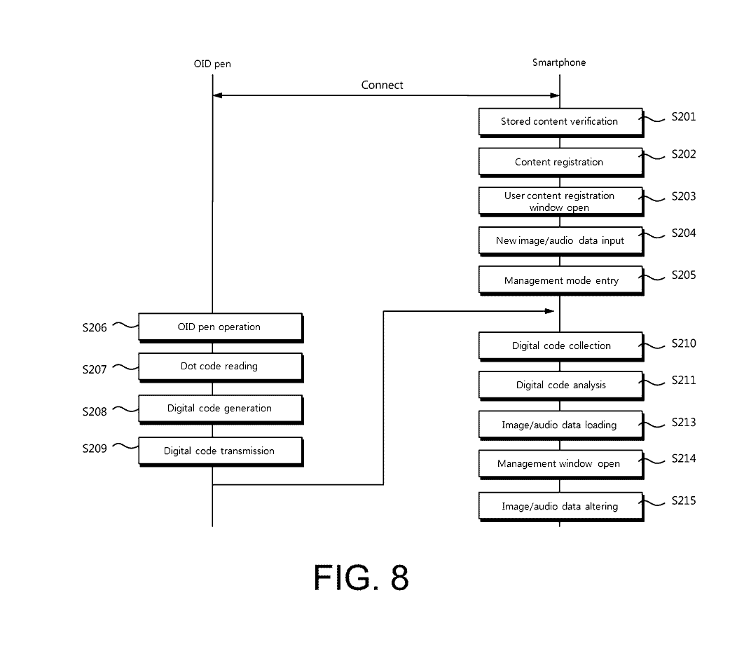

For reference, according to an embodiment of the present invention, as illustrated in FIG. 8, when the specific content is registered, the user content registration window is opened by the generating module to request the input of the new audio data or the image data.

In this case, when the new audio data or the image data is inputted, the image data or the audio data of the specific area is directly altered by entering the management mode.

For reference, when the OID pen 10 touches the specific area of the textbook 1, the decoded digital code is obtained and the newly inputted image data or the audio data is added, deleted or altered when the audio data or the image data of the corresponding area is opened in a management window 31 based on the digital code so that the modified image data or the audio data is outputted.

Therefore, the present invention allows the teachers to alter the content to be taught according to their own style and method to teach the students even when the teachers and the students use the OID pen together in a class.

What is claimed is:

1. A learning system using an OID pen, which is inexpensive and convenient, the learning system comprising:
a plurality of textbooks in which printed materials including a text and a drawing are prepared in a form of a dot code, which is a set of a plurality of dots provided in an area of 2 mm×2 mm;
an OID pen comprising an OID lens to recognize the dot code printed in the textbook through an exposing hole formed at a front end of the OID pen and a code conversion unit to decode dot code information obtained from the OID lens to generate a digital code; and
a smartphone connected to the OID pen and comprising a storage unit to store content information and an operating application corresponding to each textbook in a designated area, a controller to load audio data or image data from a corresponding content of registered contents when the operating application is operated, and an output unit to output the audio data or the image data, which are loaded by the controller,
wherein, when the operating application, which is stored in the smartphone, is operated, any one of the contents corresponding to each textbook is selectable, and
when the OID pen reads the dot code, the smartphone receives the decoded digital code to load the image data or the audio data of the corresponding content and output the data to a display panel.

2. The system according to claim 1, wherein the smartphone comprises:
an operating module to control a control module when the operating application is operated to identify an item of each content stored in the storage unit and display the item to an opened screen;
a registering module to request a touch input of a specific content item icon among a plurality of content item icons which are opened on a screen, and when the input is completed, load the audio data and the image data of the corresponding content item;
a collecting module to collect a digital code transmitted from the OID pen when the OID pen is connected to the smart phone and reads the dot code by touching a specific area of the textbook;
the control module to identify the corresponding content registered through the registering module, load the corresponding audio data and image data from the registered corresponding content based on the digital code collected through the collecting module, and instruct to output the data; and
a playing module to externally output the loaded audio data and image data through the display panel or a speaker according to an instruction of the control module to play an image or an audio.

3. The system according to claim 2, wherein the smartphone further comprises a connecting module connected to a specific WAP (Wireless Application Protocol) page on the opened screen through the operating module to download a new content and a login module to verify an identity of a connecting person.

4. The system according to claim 2, wherein the smartphone further comprises a generating module to request an input of a new image, text information or audio information and add/delete/alter the audio data or the image data loaded based on the digital code obtained through the collecting module when the input is completed.

5. The system according to claim 1, wherein the OID pen further comprises a Wi-Fi module or a Bluetooth module to wirelessly communicate with the smartphone.

6. A learning method using an OID pen, which is inexpensive and convenient, the learning method comprising:
connecting the OID pen and a smartphone in a wired or wireless manner;
operating an operating application stored in a storage unit of the smartphone;
identifying a content stored in the storage unit by the operating module of the smartphone controlling the control module, and displaying an item of the content as an icon on a screen;
registering an icon of a specific content item among the icons of the multiple content items displayed on the screen of the smartphone by touching the icon;
reading a dot code at an area touched by the OID pen using an OID lens of the OID pen when the OIOD touches a specific area of a specific textbook;
generating a digital code by decoding the dot code which is read through the OID lens by a code conversion unit of the OID pen;
outputting the digital code to the smartphone by the OID pen;
collecting the digital code by the smartphone connected to the OID pen and reporting the digital code to a control module;
analyzing the digital code which is reported from the registered content by the control module and loading audio data and image data corresponding to the digital code; and
guiding an audio or an image by externally outputting the audio data and the image data loaded according to an instruction of the control module by the playing module.

7. The method according to claim 6, wherein the registering of the icon of the specific content item by touching the icon comprises:
requesting an input of new audio data or image data by opening a user content register window by a generating module of the smartphone; and
altering the image data or the audio data of the specific area by entering a management mode in the smartphone.

8. The method according to claim 6, wherein the altering of the image data or the audio data of a specific area by entering the management mode in the smartphone comprises:
obtaining the digital code decoded by the smartphone when the specific area of the textbook is touched;
loading the audio data or the image data by analyzing the digital code obtained by the smartphone;
displaying the audio data or the image data on the management window; and
outputting modified image data or audio data by adding, deleting or altering the image data or the audio data which are newly inputted into the management window by the smartphone.
